(19) United States
(12) Patent Application Publication
(10) Pub. No.: US 2015/0123623 A1
(43) Pub. Date: May 7, 2015

(54) PRIME MOVER GENERATOR SYSTEM FOR SIMULTANEOUS SYNCHRONOUS GENERATOR AND CONDENSER DUTIES

(71) Applicant: Bechtel Power Corporation, Frederick, MD (US)

(72) Inventors: Seyfettin C. Gülen, Middletown, MD (US); Mark S. Boulden, Middletown, MD (US)

(73) Assignee: Bechtel Power Corporation, Frederick, MD (US)

(21) Appl. No.: 14/072,947

(22) Filed: Nov. 6, 2013

(51) Int. Cl. H02P 9/02

(52) U.S. Cl. CPC H02P 9/02
USPC 322/20

(57) ABSTRACT

An electric power generation plant has at least two synchronous machines and a source of mechanical power (torque), coupleable such that one or more of the synchronous machines can be operated as a generator while one or more is operated as a synchronous condenser. Field exciters, controlled shaft couplings, starters and switching sequences control starting, restarting and switching into simultaneous operation as generators, as condensers, or as one or more generators and condensers synchronously coupled to one another along a drive train. The disclosed configurations include modifications of existing generator installations such as decommissioned plants, such as by controllably coupling a second synchronous machine to a drive train, for use as a condenser for power factor control when needed or as an added source of generator capacity during times of high demand.

### FIELD OF THE INVENTION

This invention concerns methods and apparatus for coupling two or more synchronous rotating electrical machines to a prime mover driver (such as a steam, gas or water turbine, a diesel engine, etc.) that supplies torque to a drive train using shaft couplings and associated controls selectively to cause either or both of the electrical machines to work as a generator of real power to an electrical power transmission system, or as a synchronous condenser to supply reactive power to the system. In addition to supporting different operational conditions, provisions are made for starting, stopping, switching over and synchronizing rotation of the two or more rotating machines and the prime mover, using controllable shaft coupling elements.

### BACKGROUND

Synchronous machines belong to a special class of rotating electrical machines, whose shaft rotational speed corresponds to an alternating current (AC) due to periodic alignment and misalignment of magnetic poles provided on a rotor and a stator. An AC magnetic field can be created in the poles by the field current (commonly known as the excitation current). The field rotates at the speed of the rotor so that the machine produces a steady torque when operated as a motor and can turn a mechanically loaded shaft. If instead torque is applied to the shaft of the machine, an alternating current is produced and the machine operates as an electric generator. The excitation current can be varied relative to the alignment of the rotor and stator poles. When the machine is operated synchronously as a motor, the magnitude of the excitation current can be varied to cause the machine to affect the phase relationship of current and voltage on a power transmission line, namely by storing and releasing electromagnetic energy with a phase determined by the relative phases of the rotor and stator poles, the excitation current and the voltage and current conditions in the power transmission line.

Synchronous machines are commonly used as electric power generators coupled to constant speed drives such as steam or gas turbines. Since the reactive power generated by a synchronous machine can be adjusted by controlling the magnitude of the excitation current, unloaded synchronous machines can be employed in power systems solely for power factor correction or for control of reactive power flow (commonly known as reactive volt-amperes or VAR). Such machines are known as synchronous condensers, and may be more economical in large sizes than static capacitors when used to store and release phased current. When mechanically unloaded, the machine naturally rotates at the speed dictated by the ac power line, and the reactive power it supplies to the power line is determined by the amplitude of the excitation current.

The same machine can be used as a generator or condenser, but mechanical as well as electrical synchronization need to be taken into account. For instance, torque supplied to a synchronous machine brings it up to the speed necessary to synchronize it with the local electric power grid, whereupon it can be operated as a generator. The generator can be disconnected from its torque producing driver (e.g., a gas turbine or electric motor). Thereafter, the generator acts as a motor driven by the electrical grid. The motor supplies VAR to the grid while drawing leading current from it when overexcited and absorbing VAR from the grid while drawing lagging current from it when under-excited.

Reactive power is a difficult engineering concept to understand. The difficulty mostly stems from the absence of a robust analogy to simple mechanical systems (e.g., fluid flow in a pipe), which captures all salient features of AC systems, of which reactive power is a vital component, in generation as well as transmission. The best analogies involve simple hydraulic systems, e.g., flow of water in a channel feeding a water wheel. The flow rate of water in, say, gallons per minute is analogous to electric current. The voltage is analogous to the pressure or hydraulic head between the water reservoir and the water wheel. Only a portion of the total flow in the channel pushes the wheel and does useful work (analogous to the real or active power in AC systems). The remainder flows around the wheel without doing any work at all (analogous to the reactive power). If, however, the channel was designed such that only the amount of water that did work was allowed to flow through it, the stream would not be deep enough for the wheel to turn.

Reactive power establishes and sustains the electric and magnetic fields of AC equipment, charging and discharging capacitive and inductive loads at the frequency of the periodic AC power line. The AC system consumes reactive power to keep electricity flowing. Arguably, like a portion of water flow not doing any work, reactive power does not do the same sort of work as simple E=IR electricity, e.g., keeping lights on and the TV running. As the amount of electricity flowing in a transmission line increases, so does the amount of reactive power needed to move the additional electricity and maintain the proper voltage. The longer the distance (i.e., the transmission line) between the power source (i.e., the generating station) and the load (i.e., factories, houses, schools, etc.) the more reactive power is consumed due to the added reactive movement of current through the resistance of the transmission line.

When reactive power is insufficient, voltage drops. If it continues to drop, protective equipment will shut down affected power plants and lines to protect them from damage. Eventually, in analogy to the loss of water head in the channel and resulting stoppage of the water wheel due to insufficient water flow rate, the system will come to a halt. In fact, according to a report from Cornell University's Engineering and Economics of Electricity Research Group, reactive power shortages played a key role in the Northeastern Blackout on Aug. 14, 2003. Similarly, a Power Systems Engineering Research Center report comes to a similar conclusion with regard to the 1996 WECC (Western Electricity Coordinating Council) blackouts.

Reactive power shortages are caused by a variety of factors: plant retirements, plant trips, transmission line failures and peak electricity demand. Synchronous AC generators of thermal, hydraulic and nuclear power plants produce real power and reactive power. They can be adjusted to change the output of both. The ratio between the two is determined by the power factor (PF), which is the cosine of the angle (θ) between the real power and volt-amperes (VA, the apparent power). The ratio of the reactive power to the real power is equal to the tangent of θ. For example, for a 500 MW (real) generator with a PF of 0.9, θ is about 26 degrees and reactive power is 242 MVAR. Dropping the PF to 0.8 would increase θ to ˜37 degrees and increase reactive power to ˜335 MVAR, but at the expense of real power, which is now ˜444 MW.

Furthermore, the ability of a synchronous AC generator to absorb power is described by a reactive capability curve (see FIG. 1). In this curve, the VAR produced or absorbed is on the y-axis (positive going up). The x-axis shows real power in kW (positive to the right). VAR and kW are shown as per unit quantities based on the rating of the generator (not necessarily the generator set, including the prime mover driving the generator, which may have a lower rating).

The normal operating range of a generator set is between zero and 100 percent of the kW rating of the generator (positive) and between 0.8 and 1.0 power factor (labeled 1 on curve). Nearly normal output (above line 2) can be achieved with some leading PF load (˜0.95). The reason that the reactive capability curve is not a perfect circle going through the MVA rating (pu=1) is due to the two heating limits: (i) field current heating limit above line 3 and (i) armature core end heating limit below line 2. Above line 3, the machine cannot operate as a generator but it can operate as a condenser. Thus, about 30% more reactive power can be produced in the condenser mode.

There are other methods to inject VAR into the system. Two widely employed “VAR generators” are shunt capacitor banks and synchronous condensers. Newer technologies are static VAR compensators (SVC), which comprise thyristor-switched reactors and capacitors to provide rapid and variable reactive power, and self-commutated VAR compensators.

Synchronous condenser, as described earlier, is essentially an unloaded and overexcited synchronous motor. Synchronous condensers can be used at both distribution and transmission voltage levels to improve stability and to maintain voltages within desired limits under varying load conditions and contingency situations. They are superior to capacitor banks in terms of harmonics (no resonance), robustness, smooth response (no voltage spikes) and they can be cost-effective at large sizes. The advantage of synchronous condensers vis-à-vis static compensators lies in their ability to handle high temporary overloads and to provide short circuit support. However, they cannot be switched on/off as fast as SVCs and they cost much more (not to mention the size and weight requiring reinforced concrete foundations).

Regional transmission organizations such as PJM continuously monitor and manage reactive power. A regional transmission organization (RTO) in the United States is an organization that is responsible for moving electricity over large interstate areas. An RTO coordinates, controls and monitors an electricity transmission grid that is larger than the typical power company's distribution grid with much higher voltages.

In particular, RTOs:
gather real-time information about voltage levels and the need for reactive power at various locations on the grid;
limit the amount of energy that can move from point to point if there is insufficient generation locally to produce the needed reactive power;
adjust the output of generating stations under its control to increase the supply of reactive power when it is needed;
pay generation owners to compensate them for lost energy revenue when they must increase their output of reactive power at the expense of megawatts (see the numerical example above); and,
require new generators connecting to the grid to agree to specific reactive-power obligations, with financial penalties for noncompliance.

Thus, there is clearly a financial incentive for generators to provide reactive power generation capability without adversely affecting their real power generation capability, which, after all, is their main revenue source.

Two factors must be considered in a cost-performance trade-off to justify the acquisition of reactive power generation capability: initial investment versus frequency of use (revenue stream) and balance of real-reactive power generation

A recently implemented solution is conversion of an idle synchronous AC generator of a decommissioned turbine-generator plant into a synchronous condenser. (See, “Teaching old generators new tricks,” R. Peltier, POWER, November/December 2003, pp. 33-38.) . In fact, one OEM offers a packaged engineering solution for conversion of an existing synchronous generator to a synchronous condenser. (See, “Converting existing synchronous generators into synchronous condensers,” J. M. Fogarty, R. M. LeClair, Power Engineering, October 2011.). In 2003, GE Aeroderivative and Package Services (APS) in Houston retrofitted an LM6000 aero-derivative GT at ATCO Power's Valleyview Generating Station in Alberta Canada with a SSS or “Triple-S” (Synchro-Self-Shifting) clutch, which enables the unit to be used in power generation or synchronous condenser modes depending on the grid demand. (The SSS clutch is a product of SSS Clutch Company Inc. in Delaware, USA. It is a freewheel type, overrunning clutch, which transmits torque through concentric, surface-hardened gear teeth.) The SSS clutch allows the GT to be shut down while the generator remains synchronized to the grid, supplying or absorbing VAR. When real power (MW) is needed, the plant DCS restarts the GT and engages the generator via the SSS clutch.

Finally, synchronous condensers can potentially improve HVDC (High Voltage Direct Current) conversion terminal performance. In particular, line commutated current source converters (CSCs) can only operate with the AC current lagging the voltage, so the conversion process demands reactive power. Reactive power is supplied from the AC filters, which look capacitive at the fundamental frequency, shunt capacitor banks, or series capacitors that are an integral part of the converter station. Any surplus or deficit in reactive power from these local sources must be accommodated by the AC system. This difference in reactive power needs to be kept within a given band to keep the AC voltage within the desired tolerance. The weaker the AC system or the further the converter is away from generation, the tighter the reactive power exchange must be to stay within the desired voltage tolerance. (See, “The ABCs of HVDC transmission technologies,” M. P. Bahrman, B. K. Johnson, IEEE Power & Energy Magazine, March/April 2007, pp. 32-44.)

### SUMMARY OF THE INVENTION

An object of the invention is to provide a power train method and apparatus comprising a prime mover and two or more synchronous machines in tandem connected via a series of clutch couplings of various types suitable to the requirements of the particular connection.

The power train can operate in at least three modes, namely as a generator only (real power, MW, generation); as a condenser only (reactive power, MVAR, generation; and as a generator and condenser (simultaneous generation of MW and MVAR). Additional modes are possible with additional synchronous machines and/or configurations for their coupling to electric transmission lines.

An aspect of the invention is that, unlike conventional power train configurations, controlled generation of real power and adjustable reactive power are made possible simultaneously in the same power train.

These and other objects and aspects are accomplished in an alternating current power configuration including a source of mechanical torque operable to rotate a drive shaft coupled to a drive train; a first rotating machine having a rotor and stator, the first rotating machine being mechanically coupleable to the drive train and electrically coupleable to electric power transmission lines; a second rotating machine having a rotor and stator, the second rotating machine being mechanically coupleable to the drive train and electrically coupleable to the power transmission lines; at least one controller operable to apply field excitation to at least one of the first and second rotating machines, wherein the controller is configured selectively to operate one or both of the first and second rotating machines as an electric power generator converting rotational work of the drive shaft to electric current for supplying electric power to the electric power transmission line and to operate one or both of the first and second rotating machines as a synchronous condenser adjusting the field excitation for supplying reactive electric power to the electric transmission line; and, wherein during operation, the first and second rotating machines are mechanically coupled to one another by the drive train so as to rotate synchronously.

In one arrangement, at least one controllable mechanical coupling is included between at least one of the first and second rotating machines and the drive train for selectively engaging with the drive train for synchronous rotation. The controller advantageously is configured in a startup mode to operate at least one of the first and second rotating machines as a motor, for driving said at least one of the first and second rotation machines up to synchronous rotation with the drive train, and wherein the controllable mechanical coupling is engaged during an operational mode and disengaged during the startup mode.

The source of mechanical torque can be rigidly coupled to the first and/or second rotating machine through the drive train, or a transmission arrangement can be involved providing a change in speed and torque. Furthermore, it should be understood that the designation of a machine as “synchronous” generally refers to synchronous operation of electromagnetic poles, which can be achieved with differences in mechanical rotational speed, for example if there are differences in the number of poles around a circumference. Likewise, voltages and currents that appear at the respective poles may be caused to lead or lag the physical poles for adjusting operational and particularly reactive operation.

In one embodiment, the source of mechanical torque is coupled to the first rotating machine through a common drive shaft. The source of mechanical torque can include a gas turbine, steam turbine, water in a hydroelectric embodiment or the like.

Advantageously, the controller is operable according to a programmed sequence to startup and operate at least one of the first and second rotating machines to apply power to the electric power transmission line, to startup and operate at least one of the first and second rotation machines as a synchronous condenser, and to control the excitation of the synchronous condenser for maintaining a power factor according to control parameters.

The controllable mechanical coupling can include at least one of a contact clutch for rotationally decoupling between the drive train and said one of the first and second rotating machines operated during the startup mode as a motor, and a slip clutch for applying torque across a coupling for bringing one of the first and second rotating machines up to synchronous rotation with the drive train.

The controller and the first and second rotating machines are advantageously operable selectively to assume operating modes comprising at least: a full generation mode wherein both of the first and second rotating machines are synchronously coupled to the drive train to generate real power supplied to the electric transmission lines; a mixed mode wherein both of the first and second rotating machines are synchronously coupled to the drive train, one of the first and second rotating machines is operated to generate said real power supplied to one or more of the electric transmission lines while another of the first and second rotating machines is over-excited or under-excited for applying leading or lagging current reactive power to one or more of the electric transmission lines; and a condenser mode wherein both of the first and second rotating machines are synchronously coupled to the drive train and each is one of over-excited and under-excited for applying leading or lagging current reactive power to one or more of the electric transmission lines.

One or more additional rotating machines can be mechanically coupleable to the drive train for synchronous operation with at least one of the first and second rotating machines, for further potential modes of operation.

### BRIEF DESCRIPTION OF THE DRAWINGS

The drawings depict a number of arrangements and alternatives as illustrative examples but should be regarded as nonlimiting. The invention is also capable of other configurations in accordance with the claims. In the drawings,

FIG. 1 is a graph showing real power and reactive power operating conditions of a typical synchronous AC generator coupled to a loaded power transmission line. The bold line on the Y-axis represents the range of operation of a synchronous condenser.

FIG. 2 is a drive train block diagram showing an embodiment of the present invention.

FIG. 3 is a graph showing the torque-speed characteristic of a variable fill fluid coupling (VFFC) for use in the embodiment of FIG. 2.

FIG. 4 is a drive train block diagram showing the mechanical coupling of generators and/or condensers through a variable fill fluid coupling and a gear transmission.

FIG. 5 a drive train block diagram showing an alternative embodiment of the invention.

### DETAILED DESCRIPTION

An electric power generation system according to the invention applies a source of mechanical torque to a coupled set of at least two synchronous rotating machines and operates the synchronous machines selectively as generators, synchronous condensers, or advantageously to serve as one or more generators and one or more synchronous condensers operating simultaneously, coupled to a power transmission line leading to various electrical loads.

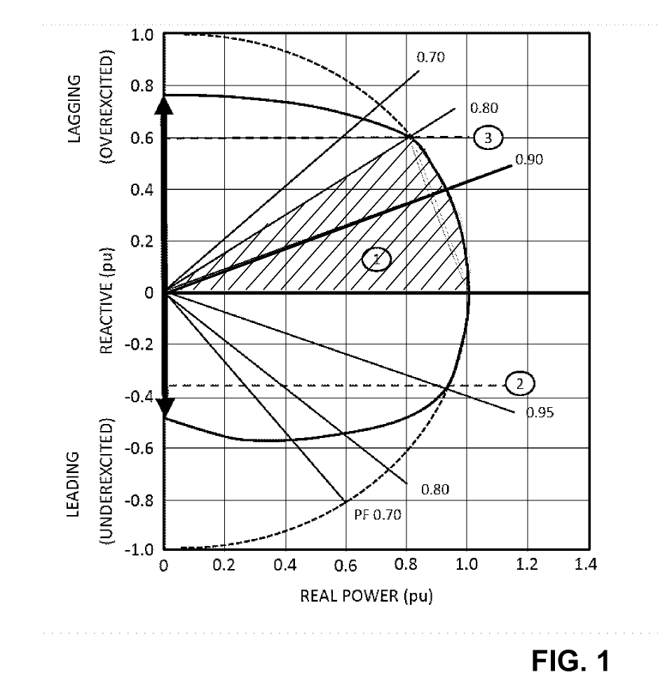

An alternating current electric power source coupled to a theoretical wholly resistive load is characterized by current and voltage AC characteristics that are in phase. A practical load, however, is partly resistive and partly reactive, i.e., capacitive or inductive. In that case, an AC power signal from a generator is associated with an AC current signal that leads or lags the voltage signal in phase to account for the di/dt characteristics of the reactive loads as the capacitive and inductive elements charge and discharge. FIG. 1 shows a range of exemplary conditions in which the current leads or lags the voltage and the associated power factors ranging between ±1.

A synchronous condenser operates to adjust the nature of the power transmission system so as to impose a desired power factor. This is accomplished by contributing to the phase relationship of the current and voltage levels in the system by phase modulating the current and voltage characteristics at the synchronous condenser. More particularly, the synchronous condenser is operated as a motor with a rotor coupled mechanically to the generator, excited by field winding excitation to achieve the desired reactive effect. As shown by the bold line on the y-axis in FIG. 1, the synchronized condenser is overexcited or underexcited to adjust the current-voltage phase characteristics on the electric power transmission line.

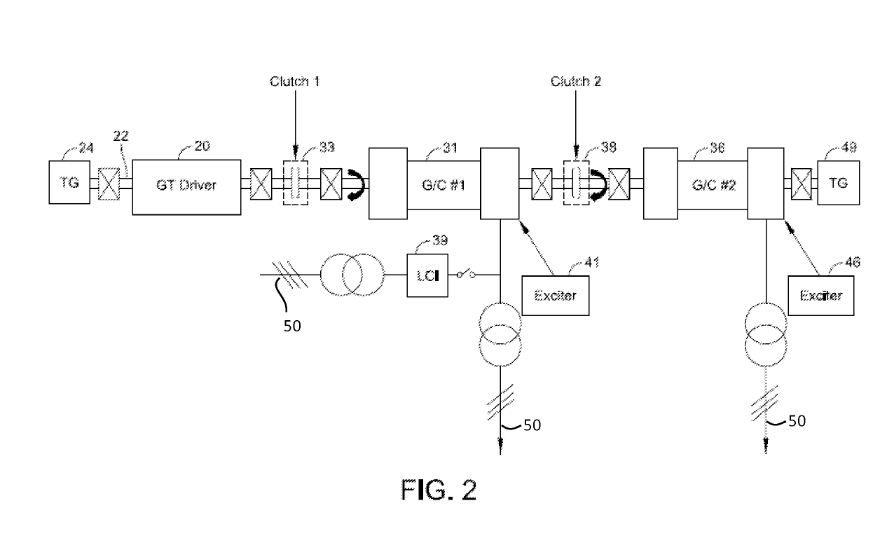

As shown in FIG. 2, the original source of power is a prime mover driver 20 applying torque to a drive shaft 22 that is suitably mounted on turning gear (TG) 24. In this example, the prime mover is shown as a gas turbine driver GT that is directly coupled to shaft 22. The invention is equally applicable to other prime movers as well as sources of torque generation, which are amenable to being used with synchronous ac generators.

A first synchronous machine 31 (G/C #1) is coupled to the prime mover driver 20 via a clutch 33 (Clutch 1). Clutch 33 advantageously can be a synchronizing clutch coupling (SCC), such as a RENK-MAAG Type DS with “engage” and “free wheel” features (commands), or a SSS clutch coupling, preferably with lock-in capability for static start applications. An integrated synchronizing clutch coupling and fluid coupling (FC) system is the RENK-MAAG Type HS-H system.

A second synchronous machine 36 (G/C #2) is coupled to the first synchronous machine 31 (G/C #1) via another clutch 38 (Clutch 2), which can be an SCC or a combination of a variable fill fluid coupling (VFFC) and a gearbox (see also FIG. 4). The clutches 33, 38 enable the synchronous machines 31 and/or 36 to be variably coupled to the drive shaft 22 when being brought up to speed via mechanical torque, for operation as a generator, or selectively and synchronously coupled to the drive shaft 22 after being brought up to speed from the power line as an unloaded synchronous motor that is then varied as to field excitation to function as a synchronous condenser. One or both of the synchronous machines can be operated to apply power to transmission lines 50; one or both of the synchronous machines can be operated as a synchronous condenser to supply reactive power to the transmission lines 50; or the two synchronous machines can simultaneously serve as a generator and a synchronous condenser.

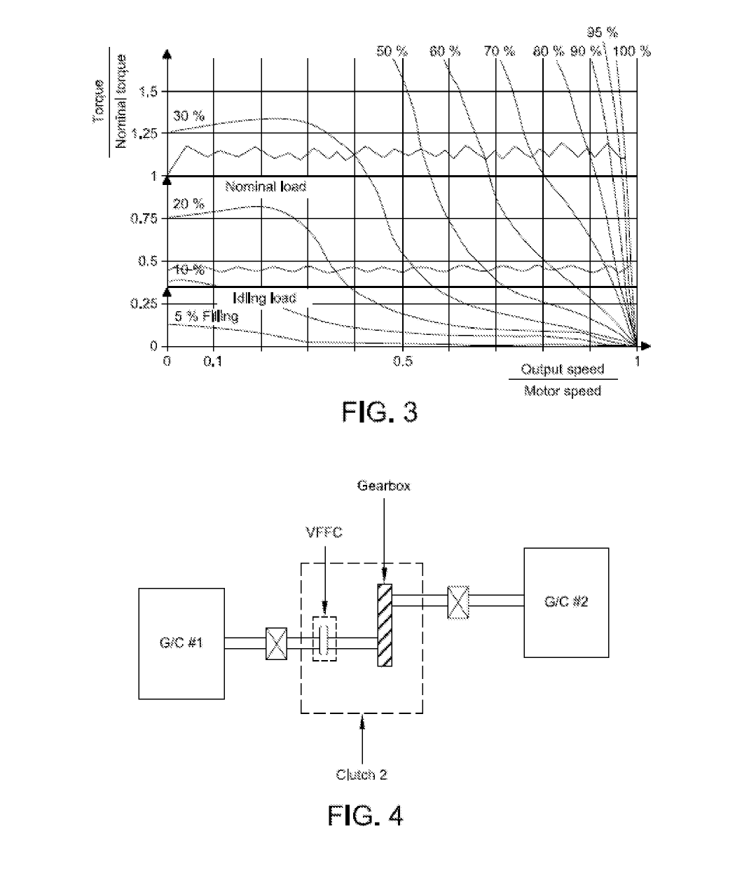

A typical variable fill fluid coupling (VFFC) speed-torque curve is shown in FIG. 3. Assuming normal operation wherein the input torque delivered by the Driver 20 to the drive train including the first synchronous machine 31 (G/C #1) is at its nominal design value and the fluid coupling of the clutch 38 is fully filled (100%), the output speed at second synchronous machine 36 would typically be slightly less than the input speed from the driver 20 (such as about 97-98%). Thus, when the input speed is 3,000 or 3,600 rpm (for 50 Hz or 60 Hz units, respectively), the output speed, without a gearbox, would be, for example, about 2,900 or 3,500 rpm, respectively. The second synchronous machine 36 can be brought up to synchronous speed via a gearbox with an output/input speed ratio of 1.025 to 1.030 to compensate for the VFFC of clutch 38. It is also possible to use a non-fluid coupling for the clutch 38 (Clutch 2) to obtain synchronous operation without using a gearbox.

Depending on whether the shaft couplings are along a rigid connection or perhaps geared or perhaps coupled through a clutch with at least temporary slippage, starting up one or both of the first and second synchronous machines 31, 36 may require that one or both of the machines 31, 36 be decoupled mechanically from shaft 22 or decoupled electrically from the grid. For example if machine 31 is operating as a generator, starting machine 36 may require that machine 31 be disconnected from the grid and undergo some degree of roll down. Roll down and the time disconnected from the grid can be minimized by connecting a Load Commutating Inverter (LCI), also known as a Static Starter, to the synchronous machine, e.g., by coupling an LCI to second machine 36 (G/C #2) to accelerate the second machine 36 (G/C #2) to near synchronous speed. This minimizes the disruption of unloading and momentarily disconnecting the first machine 31 from the grid, then mechanically engaging second machine 36 to the first machine 31 such that both machines 31, 36 are synchronously coupled to shaft 22, followed by immediate resynchronization with the grid and application of loading.

For initially starting the system, a diesel or electric starting motor can be provided (not shown for the purpose of simplicity) or the LCI 39 can be operated to drive the first synchronous machine 31 (G/C #1) as a motor to provide starting torque and power until the gas turbine driver 20 reaches ignition and self-sustaining speed.

Each synchronous machine 31, 36 is coupled to an independently controlled exciter 41, 46, which provides the field current to the rotor of each machine. During operation as a condenser, the exciter 41 or 46 adjusts the field current. During operation as a generator, the exciter 41 or 46 can provide a field that achieves the required frequency of generated AC power by taking into account the rotational speed of the shaft 22 and the rotational frequency of the applied field current. The exciters 41, 46 are configured to supply the field current commensurate with the nameplate power factor of each machine for maximum reactive power generation. For example, for a 275 MVA rated machine, exciter power is around 500 kW and field current at the rated power factor PF (typically 0.85-0.90) is about 1,500 A.

The exciters 41, 46 and the clutches 33, 38 are coordinated by control signals from a control system, preferably as an integral part of the plant's distributed control system, DCS. An exemplary control system is GE's Mark VI. The control system carries on control of operational parameters and effects individual steps according to the operational philosophies of the plant. The control system monitors protection systems, operates breakers, invokes auxiliary systems, regulates the respective elements and generates reporting information according to the status of the synchronous machines and operator control selections.

Mechanically, each of the synchronous machines 31, 36 should have a combined thrust/journal bearing to properly support its rotor, at least during condenser mode operation wherein the machine 31 or 36 can be decoupled from the rest of the power train. Thus in the embodiment shown, the second synchronous machine 36 (G/C #2) has a separate turning gear (TG) 49.

An advantageous operational philosophy is described below. Although in these examples, the prime mover is described as a gas turbine, the prime mover can be any type of engine. The description below assumes that the prime mover a gas turbine (GT) with a static starting system. When using other sources of torque, the operational states may vary and the controls and protocols applicable to such different sources will be apparent to a person of ordinary skill.

In starting the exemplary gas turbine embodiment, clutch 38 (Clutch 2) is initially disengaged. Both synchronous machines 31, 36 (G/C #1 and G/C #2) are idle. The GT is on turning gear (TG); Clutch 33 (Clutch 1) is disengaged. (Note: For SSS clutch applications with static starting, the clutch 33 may be engaged during turning gear operation and locked in to prevent disengagement when torque applied from synchronous machine 31 (G/C #1) is in the opposite direction from its direction in the generator operating mode).

The controller initiates operation of LCI 39 to start up synchronous machine 31 (G/C #1). More particularly, LCI 39 operates machine 31 as a motor coupled to shaft 22. This accelerates the gas turbine 20 up to ignition speed (for example, 15% of nominal operational speed).

If clutch 33 (Clutch 1) is a synchronizing clutch coupling (SCC), an “engage” command is applied. When the shaft of machine 31 (G/C #1) overruns the gas turbine shaft 22, the clutch 33 engages automatically (irrespective of rotational direction). The GT driver 20 and machine 31 are then coupled.

If clutch 33 (Clutch 1) is an integrated SCC+FC clutch, initially the synchronizing clutch coupling (e.g., RENK-MAAG Type HS-H) is disengaged. The gas turbine is stationary. The LCI starts synchronous machine 31 as a motor. The fluid coupling (FC) is filled, and that accelerates the gas turbine while providing a mechanical coupling of machine 31 and GT driver 20.

Once the ignition speed of the gas turbine is reached, the controller commences the GT startup sequence. The sequence may include, for example, ignition and acceleration to self-sustaining speed (˜60% of nominal), with accompanying switching and parameter adjustments to achieve the operational torque delivering state of the GT driver 20.

The LCI 39 discontinues operation of synchronous machine 31 as a motor (i.e., disengages) when the gas turbine driver 20 reaches self-sustaining speed. (In the case of the SCC configuration mentioned above, once the gas turbine driver 20 reaches self-sustaining speed, the gas turbine keeps accelerating, and overruns the G/C #1 starting torque input, at which point the synchronizing clutch coupling SCC engages automatically. The fluid coupling can then be emptied.) Where a SSS clutch is used for clutch 33 (Clutch 1), the lock-in can be released upon shutdown or disengagement of the LCI 39, since the shaft torque is in normal direction for the generator mode.

The drive train coupled to shaft 22 reaches 102% of nominal speed. Excitation is applied by exciter 41 to first synchronous machine 31. Synchronization is achieved via controlled deceleration. Clutch 38 (Clutch 2) is then engaged (e.g., via filling of the VFFC 38). Synchronous machine 36 accelerates to synchronization speed. At synchronous speed and as coupled to shaft 22, both synchronous machines 31, 36 (G/C #1 and G/C #2) are excited by exciters 41, 46. Both machines 31, 36 can supply electric power to the grid operating as generators.

When needed, clutch 38 (Clutch 2) can be disengaged (e.g., via emptying the VFFC). Synchronous machine 36 becomes a mechanically unloaded motor powered from the grid. Machine 36 then functions as a synchronous condenser. Under control of the plant controller or in a feedback control configuration based on the sensed power factor (leading or lagging current-voltage conditions), exciter 46 over-excites or under-excites synchronous machine 36 for supplying reactive power.

Meanwhile, synchronous machine 31 (G/C #1) is still connected to the grid and generating power. If needed, the gas turbine driver 20 can be is shut down. Clutch 33 (Clutch 1) disengages (e.g., by a “free wheel” command). Then synchronous machine 31 (G/C #1) also functions as a synchronous condenser based on field currents from exciter 41.

When power is needed, the gas turbine driver can be restarted after decoupling synchronous machine 31 (mechanically and electrically) and allowing it to decelerate and to be recoupled to the gas turbine driver 20 in another startup sequence. If a SCC is used and the unit uses an LCI for starting, the first machine 31 is electrically disconnected from the grid and rolls down. The LCI 39 is activated and starts the gas turbine driver with synchronous machine 31 operated as a motor. The startup steps stated above are repeated (paragraphs [0051] to [0055]).

If an integrated SCC+FC is used, the sequence above may be used or it may be possible to the fill the FC as necessary to bring the gas turbine through a starting sequence without rolling the first synchronous machine 31 down to a full stop to match the static state of the gas turbine driver 20.

If more power is needed, VFFC is filled and second synchronous machine 36 (G/C #2) acts as a generator as well

For applications using a diesel or electric starting motor for the gas turbine driver 20 (not shown), the sequences above can be simplified, because the starting motor can roll, fire and accelerate the turbine at any point and no roll down of the G/C synchronous machines 31, 36 is required to shift one or both of them from condensing to generating mode or back.

In a typical application of the invention, synchronous machine sizing may be important. A key factor is to match the torque capability of the prime mover (e.g., the gas turbine 20) to the combined size (rotational inertia, MVA rating) of the synchronous machines 31, 36. While exact sizing considerations should be made on a case-by-case basis for application-specific technical and financial criteria, the preferred embodiment of the current invention offers a unique solution under two different scenarios as will be proposed herein.

First, a brief recap of generator technology is in order. There are three main types of generators chosen primarily according to the required power generating size of the machine (MVA) and its cooling needs: air-cooled, hydrogen-cooled and liquid-cooled. Strictly speaking, a clear-cut delineation between the different types is difficult due to the different technologies offered by different equipment manufacturers. Nevertheless, for practical purposes, one can make the following generalizations.

Typically, air-cooled generators are available and cost-effective up to 180-190 MVA for 50-60 Hz gas and steam turbine applications (less than ˜200 MW). They come in two variants: OV (Open Ventilated) and TEWAC (Totally Enclosed Water Cooled).

For advanced F, G, H and J class gas turbines with ratings pushing 300 MW and their bottoming cycle steam turbines, hydrogen cooled machines are requisite (up to 500+MVA or ˜450 MW).

(At the high end, however, it must be pointed out that at least one manufacturer offers air-cooled designs up to 400 MVA (50 Hz) and 300 MVA (60 Hz) with generator efficiencies comparable to hydrogen-cooled units.)

Hydrogen, by virtue of its low density and high thermal conductivity, is a preferred choice for larger ratings with higher efficiencies. Note that, although the generator winding is cooled by hydrogen (thus enabling a more compact design than would be possible with an air-cooled machine), ultimately the hydrogen coolant itself is cooled by water in a separate heat exchanger. Furthermore, hydrogen-cooled generators require additional auxiliary systems for hydrogen filling, purging, monitoring and shaft sealing. Therefore, in a range of 150 MVA to 200 MVA where either cooling technology might be chosen, hydrogen-cooled machines are more expensive than air-cooled machines.

Bearing these facts in mind, one embodiment of the invention involves an advanced F class gas turbine with an ISO rating of 275 MW (˜325 MVA at 0.85 PF) and a hydrogen-cooled generator. With the invention, the same gas turbine is offered with a 175 MW air-cooled G/C #1 (˜200 MVA) and 75 MW air-cooled G/C #2 (125 MVA). As such, the following operational modes are available:
At ISO base load, 275 MW rated power with both synchronous machines in generator mode;
At ISO base load, 175 MW rated power (G/C #1 in generator mode) and ˜50 to 60 MVAR reactive power (G/C #2 in condenser mode);
If necessary, both G/C #1 and G/C #2 in condenser mode for ˜200 MVAR reactive power with GT shut down;
At a particular site ambient and/or loading condition, as needed, G/C #1 in generator mode and G/C #2 off.

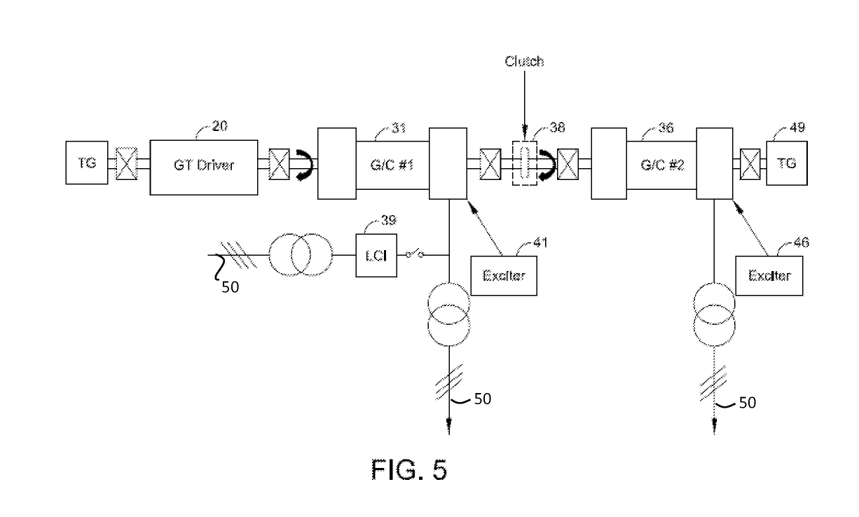

Another embodiment of the invention involves an advanced F class gas turbine with an ISO rating of 275 MW (˜325 MVA at 0.85 PF) and a hydrogen-cooled generator. An example is shown in FIG. 5 using the same reference numbers. However, in this embodiment there is no clutch/coupling 33 between the gas turbine driver 20 and the first synchronous machine 31. Therefore, this embodiment can be realized using an existing synchronous machine as machine 31, such as the generator of a decommissioned power plant rated 45 MW. That machine 31 is coupled to a second synchronous machine 36 via a clutch 38, which can be any of the clutch types discussed earlier in the disclosure but is also ideally suited to the application of an SSS clutch.

As such, the following operational modes are available:
At ISO base load, 275 MW rated power with G/C #2 off. The clutch is disengaged. In the case of an SSS clutch, the disengagement is facilitated by a servo-actuated lock-out mechanism. For other type of clutches, the disengagement is as described earlier in the disclosure.
At ISO base load, 275 MW rated power (G/C #1 in generator mode) and ˜35 MVAR reactive power (G/C #2 in condenser mode).
On a demand intensive day, such as a cold day, say, at 10° F. ambient, both G/C #1 (285 MW) and G/C #2 (45 MW) can operate in generator mode for 330 MW total power.

In the second and third of these operating modes, the clutch is engaged. In the case of a SSS clutch, the engagement is facilitated by the deactivation of the servo-actuated lock-out mechanism. The clutch then engages when the input shaft (connected to G/C #1) overruns the output shaft (connected to G/C #2). For other types of clutches, the engagement is as described earlier in the disclosure.

In the embodiment of FIG. 5, the invention enables a plant with an original gas turbine generator to be refitted with a smaller (and, thus, less costly) hydrogen-cooled generator, and the second synchronous machine serves as a condenser (when needed) or as a “topping” generator on demand intensive days. In addition, a major upgrade of the turbine can take it beyond the originally supplied generator's electrical capability by using the incremental capacity of G/C #2 without the need even to modify of the original generator other than fitting provisions for the shaft extension for coupling G/C #2.

In either embodiment, G/C #2 is significantly smaller than G/C #1, which facilitates its easy removal for pulling the G/C #1 rotor out for maintenance. (A similar procedure is used in single-shaft combined cycle power plants where the generator is between the gas turbine and steam turbine, to which it might be connected via a SSS clutch.)

The invention has been disclosed in connection with a number of exemplary embodiments and alternatives. It should be understood, however, that the invention is not limited to the embodiments disclosed as examples and is capable of additional variations within the scope of the invention as defined in the following claims.

What is claimed is:

1. An alternating current power configuration, comprising:
a source of mechanical torque operable to rotate a drive shaft coupled to a drive train;
a first rotating machine having a rotor and stator, the first rotating machine being mechanically coupleable to the drive train and electrically coupleable to electric power transmission lines;
a second rotating machine having a rotor and stator, the second rotating machine being mechanically coupleable to the drive train and electrically coupleable to the power transmission lines;
at least one controller operable to apply field excitation to at least one of the first and second rotating machines, wherein the controller is configured selectively to operate one or both of the first and second rotating machines as an electric power generator converting rotational work of the drive shaft to electric current for supplying electric power to the electric power transmission line and to operate one or both of the first and second rotating machines as a synchronous condenser adjusting the field excitation for supplying reactive electric power to the electric transmission line; and, wherein during operation, the first and second rotating machines are mechanically coupled to one another by the drive train so as to rotate synchronously.

2. The alternating current power configuration of claim 1, further comprising at least one controllable mechanical coupling between at least one of the first and second rotating machines and the drive train for selectively engaging with the drive train for synchronous rotation.

3. The alternating current power configuration of claim 2, wherein the controller is configured in a startup mode to operate at least one of the first and second rotating machines as a motor, for driving said at least one of the train, and wherein the controllable mechanical coupling is engaged during an operational mode and disengaged during the startup mode.

4. The alternating current power configuration of claim 2, wherein the source of mechanical torque is rigidly coupled to the first rotating machine through the drive train.

5. The alternating current power configuration of claim 4, wherein the source of mechanical torque is coupled to the first rotating machine through a common drive shaft.

6. The alternating current power configuration of claim 2, wherein the source of mechanical torque comprises a gas turbine.

7. The alternating current power configuration of claim 2, wherein the controller is operable according to a programmed sequence to startup and operate at least one of the first and second rotating machines to apply power to the electric power transmission line, to startup and operate at least one of the first and second rotation machines as a synchronous condenser, and to control the excitation of the synchronous condenser for maintaining a power factor according to control parameters.

8. The alternating current power configuration of claim 3, wherein the controllable mechanical coupling includes at least one of a contact clutch for rotationally decoupling between the drive train and said one of the first and second rotating machines operated during the startup mode as a motor, and a slip clutch for applying torque across a coupling for bringing one of the first and second rotating machines up to synchronous rotation with the drive train.

9. The alternating current power configuration of claim 1, wherein the controller and the first and second rotating machines are selectively operable to assume operating modes comprising at least: a full generation mode wherein both of the first and second rotating machines are synchronously coupled to the drive train to generate real power supplied to the electric transmission lines; a mixed mode wherein both of the first and second rotating machines are synchronously coupled to the drive train, one of the first and second rotating machines is operated to generate said real power supplied to one or more of the electric transmission lines while another of the first and second rotating machines is over-excited or under-excited for applying leading or lagging current reactive power to one or more of the electric transmission lines; and a condenser mode wherein both of the first and second rotating machines are synchronously coupled to the drive train and each is one of over-excited and under-excited for applying leading or lagging current reactive power to one or more of the electric transmission lines.

10. The alternating current power configuration of claim 1, further comprising at least one additional rotating machine that is mechanically coupleable to the drive train for synchronous operation with at least one of the first and second rotating machines.
